(19) United States
(12) Patent Application Publication
(10) Pub. No.: US 2025/0004718 A1
(43) Pub. Date: Jan. 2, 2025

(54) ONE-DIMENSIONAL CONVOLUTION BY BINARY SEGMENTATION ON DSP SLICES

(71) Applicant: XILINX, INC., San Jose, CA (US)

(72) Inventors: Alessandro PAPPALARDO, Bergamo (IT); Thomas Bernd PREUSSER, Dresden (DE)

(21) Appl. No.: 18/217,336

(22) Filed: Jun. 30, 2023

(51) Int. Cl. G06F 7/523

(52) U.S. Cl. CPC G06F 7/523

(57) ABSTRACT

Embodiments herein describe techniques for one-dimensional convolution by binary segmentation on DSP slices. In an embodiment, pre-processing circuitry concatenates first and second sets of binary integers as respective first and second vectors/polynomials, which are provided to a wide-input integer multiplier circuit. In an embodiment, a plurality of multiplier circuits are configured to compute a linear convolution of a kernel and a data stream over multiple cycles. Pre-processing circuitry encodes elements of a kernel as kernel polynomials, and encodes segments of a data stream as data polynomials. The multiplier circuits multiply respective pairs of the kernel polynomials and data polynomials to provide respective polynomial products. Post-processing circuitry slices outputs of the multiplier circuits to segregate terms of the polynomial products, and aggregates like-terms of the polynomial products of the multiplier circuits and terms of polynomial products of the multiplier circuits retained from one or more prior cycles.

### TECHNICAL FIELD

Examples of the present disclosure generally relate to one-dimensional convolution by binary segmentation on DSP slices.

### BACKGROUND

Convolution is a mathematical operation on two functions that produces a third function that expresses how the shape of one is modified by the other. The term convolution refers to both the result function and to the process of computing it. Convolution is defined as the integral of the product of the two functions after one is reflected about the y-axis and shifted. The choice of which function is reflected and shifted before the integral does not change the integral result. Some features of convolution are similar to cross-correlation.

In a discrete one-dimensional convolution, a stream of values is convolved with a finite set of values (i.e., a kernel). One-dimensional discrete linear convolution (and cross correlation) can be described as polynomial products between a typically short kernel vector, mapped to a polynomial b(r) and a typically long or infinite data input stream mapped to a polynomial x(r).

Applications of convolution include artificial intelligence/machine learning. or AI/ML (e.g., convolutional neural networks), image processing, radio signal processing, probability, statistics, acoustics, spectroscopy, geophysics, engineering, physics, differential equations, and other signal processing that can leverage convolutional neural networks. Discrete convolution among integer values is particularly relevant for quantized convolutional neural networks, which is a class of convolutional neural networks that leverages inputs and weights quantized to integer values.

### SUMMARY

Techniques for one-dimensional convolution among integers by binary segmentation on DSP slices are described. One example is an integrated circuit (IC) device that includes pre-processing circuitry having concatenation circuitry that concatenates first and second sets of binary integer values as respective first and second vectors, and an integer multiplier circuit that includes first and second inputs coupled to an output of the pre-processing circuitry.

Another example described herein is an IC device that includes a digital signal processor (DSP) having a plurality of multiplier circuits configured to compute a linear convolution of a kernel and a data stream over multiple cycles.

Another example described herein is an IC device that includes pre-processing circuitry that encodes elements of a kernel as kernel polynomials, and encodes segments of a data stream as data polynomials. The IC device further includes a plurality of multiplier circuits that multiply respective ones of the kernel polynomials and respective ones of the data polynomials to provide a polynomial product. The IC device further includes post-processing circuitry that slices outputs of the multiplier circuits based on a scaling factor to segregate terms of the polynomial products of the multiplier circuits, aggregates like-terms of the polynomial products of the multiplier circuits and terms of polynomial products of the multiplier circuits retained from one or more prior cycles, based on exponents of the scaling factor associated with the respective terms, outputs a set of like-terms when processing of the associated segments of the data stream is complete, and retains terms for which processing of the associated segments of the data stream is incomplete.

### BRIEF DESCRIPTION OF DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 is a block diagram of a digital signal processor (DSP) 100 that computes a one-dimensional (1D) convolution on a multiplier circuit, according to an embodiment.

FIG. 2 illustrates the DSP performing a one-dimensional convolution of two vectors, illustrated here as binomials, according to an embodiment.

FIG. 3 is a flowchart of a method of performing a 1-dimensional convolution, according to an embodiment.

FIG. 4 is a block diagram of the DSP configured to convolve a kernel b(r) with a data stream x(i), according to an embodiment.

FIGS. 5A and 5B illustrate states of the DSP 100 (as depicted in FIG. 4), as the DSP convolves a 4-element kernel b(r) with the data stream x(i), according to an embodiment.

FIG. 6 is a flowchart of a method of linearly convolving a multi-element kernel with a data stream on a single multiplier circuit, according to an embodiment.

FIG. 7 is a block diagram of the DSP, including parallel integer multiplication circuits, according to an embodiment.

FIGS. 8A-8D illustrate states of the DSP (as depicted in FIG. 7), as the DSP convolves a 4-element kernel b(r) with the data stream x(i), according to an embodiment.

FIG. 9A is a schematic diagram of a DSP slice, according to an embodiment.

FIG. 9B illustrates example mappings for convolving a 3-element input stream segment x_{i+2:i} with a 5-element kernel b_{4:0}, using a single DSP slice, according to an embodiment.

FIG. 9C illustrates example mappings for convolving a 3-element input stream segment x_{i+2:i} with a 5-element kernel b_{4:0}, using multiple DSP slices, according to an embodiment.

FIG. 10 illustrates register circuitry that updates kernel parameters, according to an embodiment.

FIG. 11 is a graph that illustrates benefits in terms of operational density per DSP slice for low-precision data types that are typical in machine-learning (ML) inference applications, according to an embodiment.

FIG. 12 is a block diagram of an integrated circuit (IC) device that includes a DSP, according to an embodiment.

FIG. 13 is a block diagram of configurable circuitry, including an array of configurable or programmable circuit blocks or tiles, according to an embodiment.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by the same reference numerals throughout the figures. It should be noted that the figures are only intended to facilitate the description of the features. They are not intended as an exhaustive description of the features or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

Embodiments herein describe one-dimensional convolution by binary segmentation on DSP slices.

Embodiments herein further describe application of binary segmentation to map a 1-D integer convolution to integer multiplication.

In an embodiment, binary segmentation techniques and slicing techniques are applied to wide integer multiplier circuits to perform parallel computations of multiple smaller products that contribute to the dot products of a linear convolution or cross correlation. Techniques disclosed herein may be used to exploit tiling of a multiplier matrix in both spatial dimensions to achieve a denser operational utilization that grows quadratically with the width of the accumulation data path. Techniques disclosed herein may be adapted and mapped efficiently to DSP slices.

Embodiments herein address various technical challenges, including application of binary segmentation techniques to signed data types, composition of arbitrarily wide DSP compute slices with a constant bounded critical path, and exploitation of binary segmentation techniques in multidimensional convolutions. Embodiments herein further describe techniques for updating kernel weights within DSP slices, in parallel with ongoing computations, without use of on-chip buffer memory external of the DSP slices.

Embodiments herein may be useful to accelerate convolution processing.

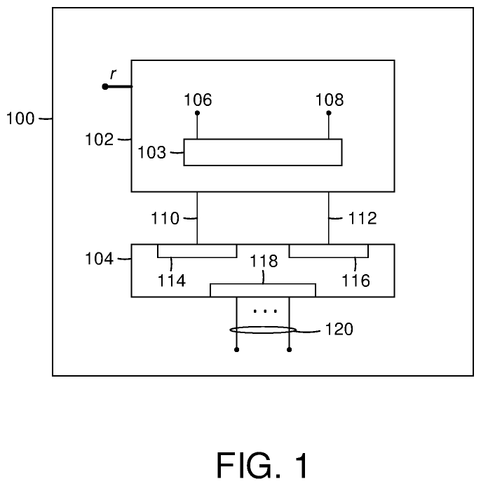

FIG. 1 is a block diagram of a digital signal processor (DSP) 100 that computes a one-dimensional (1D) convolution on a multiplier circuit, according to an embodiment. In the example of FIG. 1, DSP 100 includes pre-processing circuitry 102 and an integer multiplier circuit 104. Pre-processing circuitry 102 includes concatenation circuitry 103 that concatenates two or more binary integer values, or kernel elements 106 as a vector 110. Concatenation circuitry 103 also concatenates two or more binary integer values 108 (e.g., from a data stream) as a vector 112.

Multiplier circuit 104 receives vectors 110 and 112 at respective inputs 114 and 116, multiplies vectors 110 and 112, and provides a resultant product 120 at an output 118. Vectors 110 and 112 may represent polynomials and product 120 may represent a product of the polynomials (i.e. convolution or cross-correlation).

In an embodiment, multiplier circuit 104 is designed to compute a product of two high-precision numbers (i.e., relatively large integer values, or wide integers), and DSP 100 is configured to use multiplier circuit 104 to compute a 1D convolution of lower-precision numbers (i.e., relatively small integer values). As an example, and without limitation, kernel elements 106 and/or binary integer values 108 may be as small as 2, 3, or 4 bits, and vector 110 and/or vector 112 may include as few as two concatenated binary integer values.

DSP 100 may represent, for example and without limitation, a DSP48 arithmetic logic unit (ALU) or a DSP58 ALU developed by Xilinx, Inc. The DSP48 ALU includes an 18-bit by 25-bit signed multiplier, which may serve as multiplier circuit 104. The DSP58 ALU includes a 27×24 bit multiplier circuit, which may serve as multiplier circuit 104. Other DSP types may be used.

DSP 100 may be embedded within a fabric of a field-programmable gate array (FPGA).

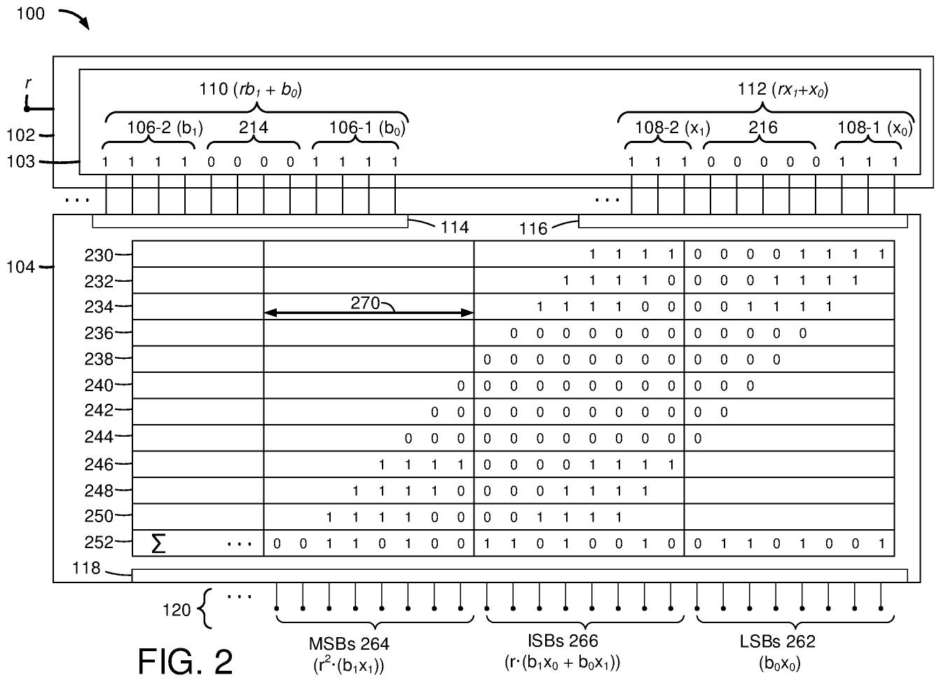

FIG. 2 illustrates DSP 100 performing a one-dimensional convolution of vectors 110 and 112, illustrated here as binomials, according to an embodiment. In the example of FIG. 2, DSP 100 computes a vector-by-vector multiplication of:

$$p = ( {rb}_{1} + {b}_{0} ) + ( {rx}_{1} + {x}_{0} ) = {r}^{2} \cdot {b}_{1} {x}_{1} + r \cdot ( {b}_{1} {x}_{0} + {b}_{0} {x}_{1} ) + {b}_{0} {x}_{0} .$$

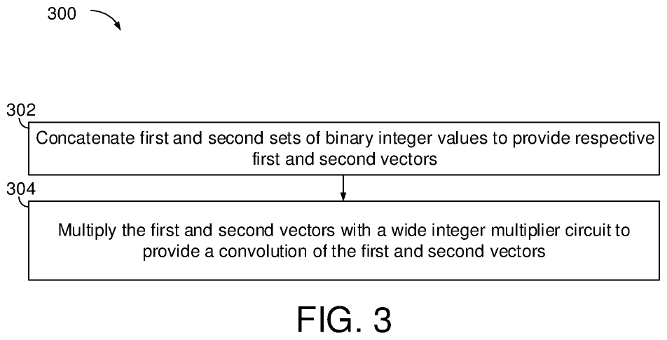

FIGS. 1 and 2 are described below with reference to FIG. 3. FIG. 3 is a flowchart of a method 300 of performing a 1-dimensional convolution, according to an embodiment. Method 300 is described below with reference to FIGS. 1 and 2. Method 300 is not, however, limited to the examples of FIGS. 1 and 2.

At 302, concatenation circuitry 103 concatenates first and second sets of binary integer values 106 and 108 to provide respective vectors 110 and 112. In the example of FIG. 2, pre-processing circuitry 102 concatenates binary integer values 106-1 and 106-2 (i.e., b₀ and b₁), as vector 110 (i.e., (rb₁+b₀)). Binary integer values 106-1 and 106-2 may represent weights or kernel elements, and vector 110 may be referred to a kernel vector, or kernel polynomial. Concatenation circuitry 103 also concatenates binary integer values 108-1 and 108-2 (i.e., x₀ and x₁), as vector 112 (i.e., (rx₁+x₀). Binary integer values 108-1 and 108-2 may represent data, and vector 112 may be referred to as a data vector, or data polynomial. In other embodiments, pre-processing circuitry 102 concatenates more than two binary integer values for vector 110 and/or vector 112 to provide vector 110 and/or vector 112 as a higher-degree polynomial.

Further in FIG. 2, pre-processing circuitry 102 pads vectors 110 and 112 with respective padding 214 and 216 based on a radix, or scaling factor r. Scaling factor r serves to shift b₁ away from b₀, and to shift x₁ away from x₀. Scaling factor r defines column widths 270, L, which is discussed further below. In the example of FIG. 2, scaling factor r=8. DSP 100 is not, however, limited to this example.

At 304, multiplier circuit 104 multiplies vectors 110 and 112 (i.e., (rb₁+b₀)×(rx₁+x₀)). In FIG. 2, a first row 230 represents a product of vector 110 and a least significant bit (LSB) of vector 112. Rows 232 through 250 represent products of vector 110 and respective subsequent bits of vector 112. Row 252 represents a sum of the products of rows 230 through 250.

Since vectors 110 and 112 represent polynomials, product 120 represents a convolution of vectors 110 and 112. In the example of FIG. 2, least significant bits (LSBs) 262 of product 120 represent a first term (i.e., (b₀x₀)) of the convolution. Most significant bits (MSBs) 264 (i.e., (r²·(b₁x₁))) of product 120 represent a second term of the convolution. Intermediate significant bits (ISBs) 266 (i.e., (r(b₁x₀+b₀x₁))) of product 120 represent one or more intermediate terms of the convolution. DSP 100 may include post-processing circuitry that segments product 120 to segregate LSBs 262, MSBs 264, and ISBs 266 based on scaling factor r.

Method 300 may be performed or repeated for additional binary integer values 106 and/or additional binary integer values 108, such as described below.

Linear convolution (and cross correlation) can be described as polynomial products between a relatively short kernel (i.e., weights bᵢ) vector, mapped to a polynomial b(r), and a relatively long or even infinite data stream xᵢ, mapped to a polynomial x(r). Powers of radix r encode positions of the components represented by the corresponding coefficients:

$$b ( r ) = {\sum }_{k = 0}^{K - 1} {r}^{k} {b}_{k}$$

$$x ( r ) = {{\sum }_{i = 0}}^{…} {r}^{i} {x}_{i}$$

After potentially reversing the order of the kernel components, both linear convolution (and cross correlation) ultimately yield a computation of a long or infinite band structure.

For a sufficiently large choice of r=2^{L}, the kernel (r) and segments of the input (r) can be mapped to wide integer inputs of a single wide integer multiplier circuit for computing multiple rows of the computation. For unsigned data, assembly of the input integers amounts to plain concatenation, such as illustrated in the examples above. The resultant product can be sliced or divided into columns, provided lane width L is able to accommodate the maximum number of bits of the dot product result. Completing an output segment of the same length as the input segment processed in each step, the partial results in higher lanes are continued in the next computation step. If a multiply-accumulate operation is available, the continuation may be accomplished by right-shifted partial results and inserting the right-shifted partial results to the additive input in the next cycle. Conventional techniques for accumulating and tracking cross-contamination across different virtual lanes may be employed. DSP 100 may extend conventional overlap-and-add (OLA) techniques and/or conventional binary segmentation techniques to linearly convolve kernels of arbitrary sizes on streaming data.

In the example of FIG. 1 and/or FIG. 2, kernel elements 106 may represent elements of a kernel bᵢ, and binary integer values 108 may represent segments of a data stream xᵢ. In this example, vector 110 may represent a relatively short kernel vector mapped to a polynomial (r), and vector 112 may represent segments of the data stream mapped to a polynomial x(r).

In an embodiment, DSP 100 processes a long and potentially unbounded stream of data (xᵢ) bounded kernel (bᵢ), examples of which are provided below.

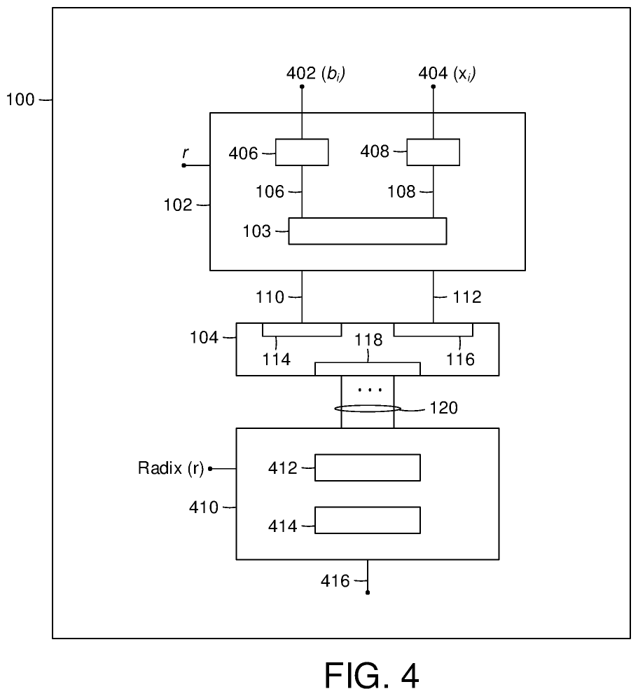

FIG. 4 is a block diagram of DSP 100, configured to convolve a kernel b(r) 402 with a data stream x(i) 404, according to an embodiment. In the example of FIG. 4, pre-processing circuitry 102 further includes selector circuitry 406 that selects elements of kernel b(r) 402 to use as kernel elements 106. Pre-processing circuitry 102 further includes segmentation circuitry 408 that provides segments of data stream x(i) 404 as binary integer values 108. In the example of FIG. 4, DSP 100 further includes post-processing circuitry 410 that includes slicer circuitry 412 and accumulator circuitry 414, which are described below.

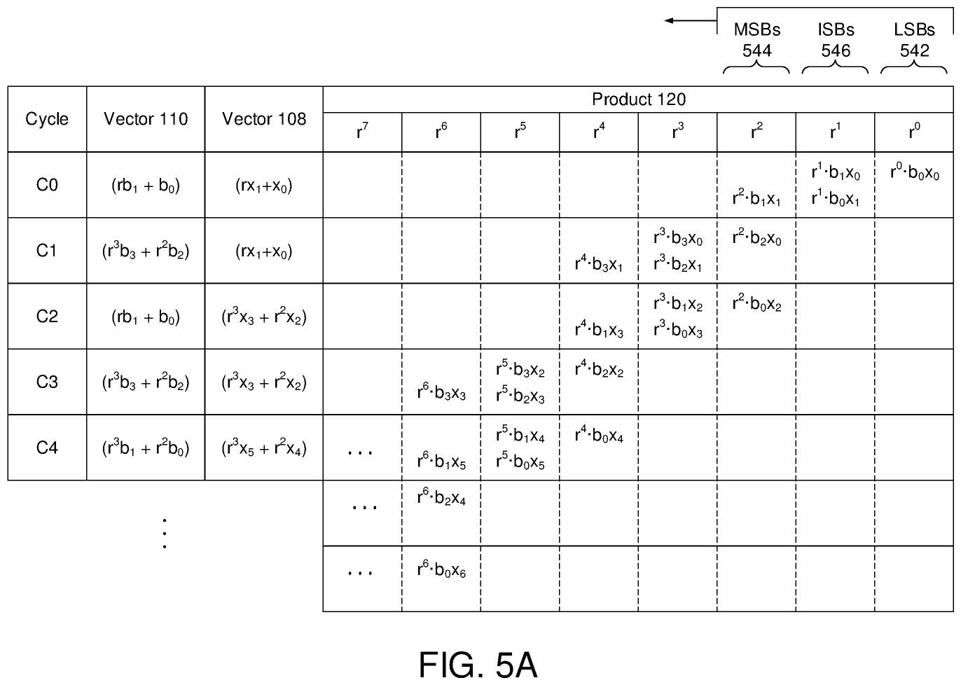

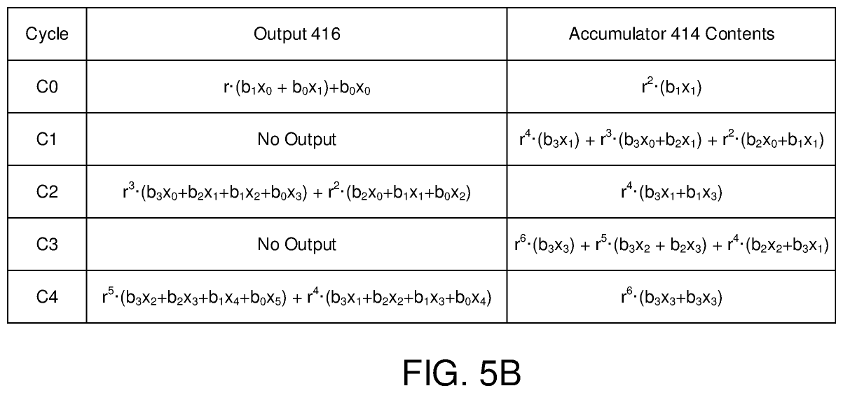

FIGS. 5A and 5B illustrate states of DSP 100 (as depicted in FIG. 4), as DSP 100 convolves a 4-element kernel b(r) 402, containing kernel elements b₀, b₁, b₂, and b3, with data stream x(i) 404, according to an embodiment.

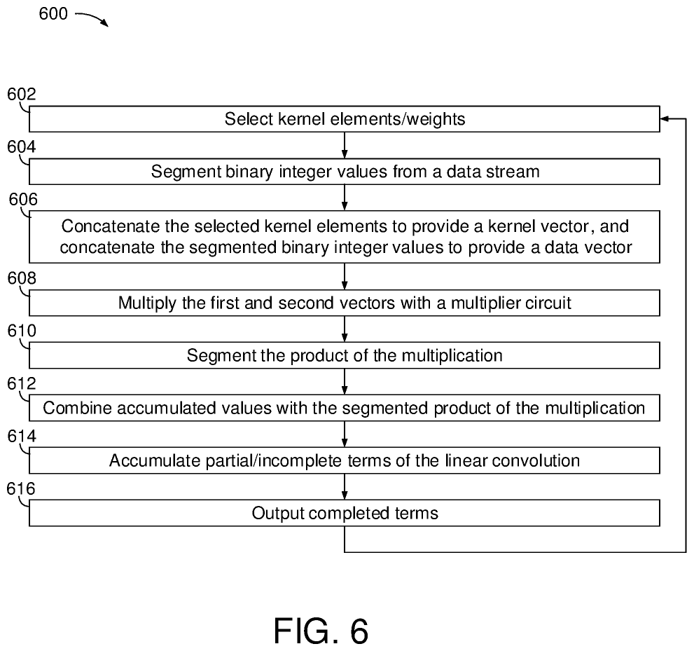

FIGS. 4, 5A, and 5B are described below with reference to FIG. 6. FIG. 6 is a flowchart of a method 600 of linearly convolving a multi-element kernel with a data stream on a single multiplier circuit, according to an embodiment. Method 600 is described below with reference to FIGS. 4, 5A, and 5B. Method 600 is not, however, limited to the examples of FIGS. 4, 5A, and 5B.

At 602, at the outset of a first cycle, C0, selector circuitry 406 selects kernel elements, or weights b₀ and b₁.

At 604, segmentation circuitry 408 segments binary integer values x₀ and x₁ from data stream x(i) 404.

At 606, concatenation circuitry 103 concatenates kernel elements b₀ and b₁ as vector 110, and concatenates segmented binary integer values x₀ and x₁ as vector 112, as illustrated in FIG. 5A for cycle C1.

At 608, multiplier circuit 104 multiplies vectors 110 and 112, such as described above with reference to 304 in FIG. 3. FIG. 5A illustrates product 120 for cycle C0.

At 610, slicer circuitry 412 slices product 120 for cycle C0 based on scaling factor r. In FIG. 5A, slicer circuitry 412 slices product 120 into LSBs 542, MSBs 544, and ISBs 546.

For cycle C0, 612 is not applicable.

At 614, accumulator circuitry 414 retains any portion of product 120 of cycle C0 that represents an incomplete portion of the linear convolution. In FIG. 5A, the r² column (i.e., MSB 544) will not be complete until the end of cycle C2. In this situation, accumulator circuitry 414 retains MSB 544 (i.e., r²·(b₁x₁)), as illustrated in FIG. 5B for cycle C0.

At 616, post-processing circuitry 410 outputs completed terms of the linear convolution at an output 416. In FIG. 5B. post-processing circuitry 410 outputs ISB 546 (i.e., r¹·(b₁x₀+b₀x₁) and LSB 542 (i.e., r⁰·b₀x₀) of cycle C0.

Processing returns to 602 for cycle C1, where selector circuitry 406 selects kernel elements b₂ and b₃.

At 604, segmentation circuitry 408 again provides binary integer values x₀ and x₁ to concatenation circuitry 103.

At 606, concatenation circuitry 103 concatenates kernel elements b₂ and b₃. as vector 110, and concatenates segmented binary integer values x₀ and x₁ as vector 112, as illustrated in FIG. 5A for cycle C1.

At 608, multiplier circuit 104 multiplies vectors 110 and 112. FIG. 5A illustrates product 120 for cycle C1 as r⁴·b₃x₁+r³·b₃x₀+r³·b₂x₁+r²·b₂x₀.

At 610, slicer circuitry 412 slices product 120 for cycle C1 based on scaling factor r (i.e., LSBs r²·b₂x₀, ISBs r³·(b₃x₀+b₂x₁), and MSBs r⁴·b₃x₁).

For cycle C1, 612 is not applicable.

At 614, accumulator circuitry 414 retains any portion of product 120 of cycle C1 that represents an incomplete portion of the linear convolution. In FIG. 5A, for cycle C1, none of columns r², r³, and r⁴ is complete. In this situation, accumulator circuitry 414 retains the entirety of product 120 for cycle C1 (i.e., LSBs r²·b₂x₀, ISBs r³·(b₃x₀+b₂x₁). and MSBs r⁴·b₃x₁), as illustrated in FIG. 5B for cycle C1.

Since there are no completed terms for the linear convolution during cycle C1, post-processing circuitry 410 does not output any completed terms for cycle C1 at 616.

Processing returns to 602 for cycle C2, where selector circuitry 406 again selects kernel weights b₀ and b₁.

At 604, segmentation circuitry 408 segments binary integer values x₂ and x₃ from data stream x(i) 404

At 606, concatenation circuitry 103 concatenates weights b₀ and b₁ as vector 110, and concatenates segmented binary integer values x₂ and x₃ as vector 112, as illustrated in FIG. 5A for cycle C2.

At 608, multiplier circuit 104 multiplies vectors 110 and 112. FIG. 5A illustrates product 120 for cycle C2.

At 610, slicer circuitry 412 slices product 120 for cycle C2 (i.e., LSBs r²·b₀x₂, ISBs r³·(b₁x₂+r³·b₀x₃) and MSBs r⁴·b₁x₃ in FIG. 5A).

At 612, accumulator circuitry 414 combines any retained portion of the linear convolution with segmented product 120 for cycle C2, if the retained portion completes an element of the linear convolution. As illustrated FIGS. 5A, at cycle C2, the r² and r³ columns are complete. In this situation, accumulator circuitry 414 combines the retained portions of the r² and r³ columns with the respective portions of product 120 for cycle C2, and discards the retained portions of the r² and r³ columns. Accumulator circuitry 414 may accumulate incomplete portions of the linear convolution, and track cross contamination across different virtual lanes, or columns based on one or more of a variety of traditional techniques. Accumulator circuitry 414 may utilize a traditional overlap-and-add (OLA) technique.

At 614, accumulator circuitry 414 retains any portion of product 120 of cycle C2 that represents an incomplete portion of the linear convolution. In FIG. 5A, the r⁴ column is incomplete. In this situation, accumulator circuitry 414 retains MSB r⁴·b₁x₃ of cycle C2, as illustrated in FIG. 5B.

At 616, post-processing circuitry 410 outputs any completed terms of the linear convolution. In FIG. 5B, for cycle C2, post-processing circuitry 410 outputs r³·(b₃x₀+b₂x₁+b₁x₂+b₀x₃), r²·(b₂x₀+b₁x₁+b₀x₂).

Processing returns to 602 for cycle C3. Method 600 may be repeated as described above, indefinitely or until data stream x(i) 404 terminates.

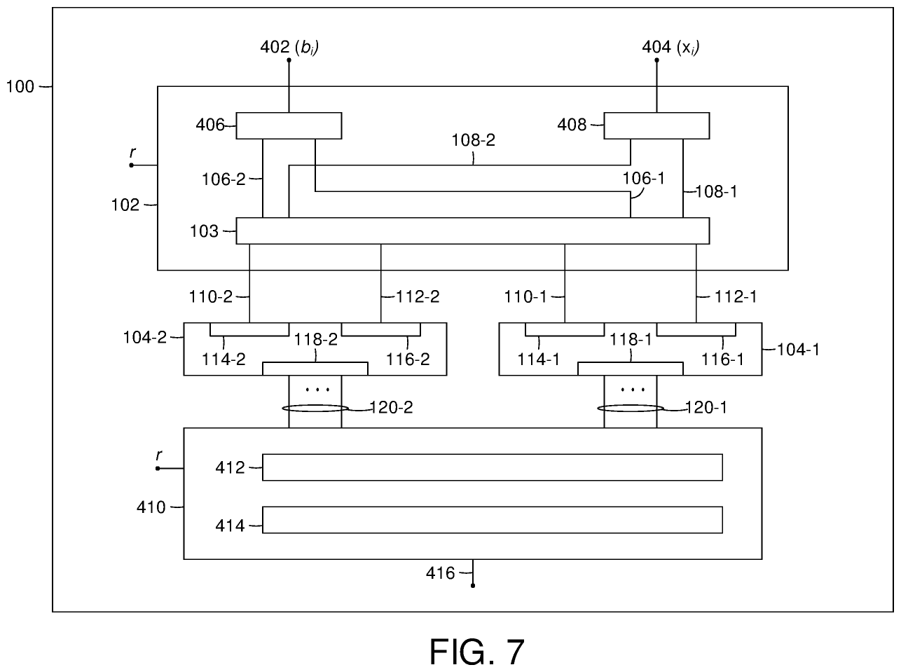

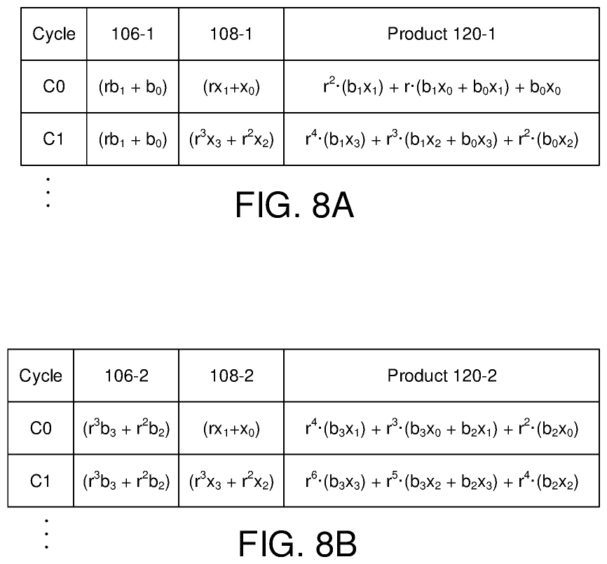

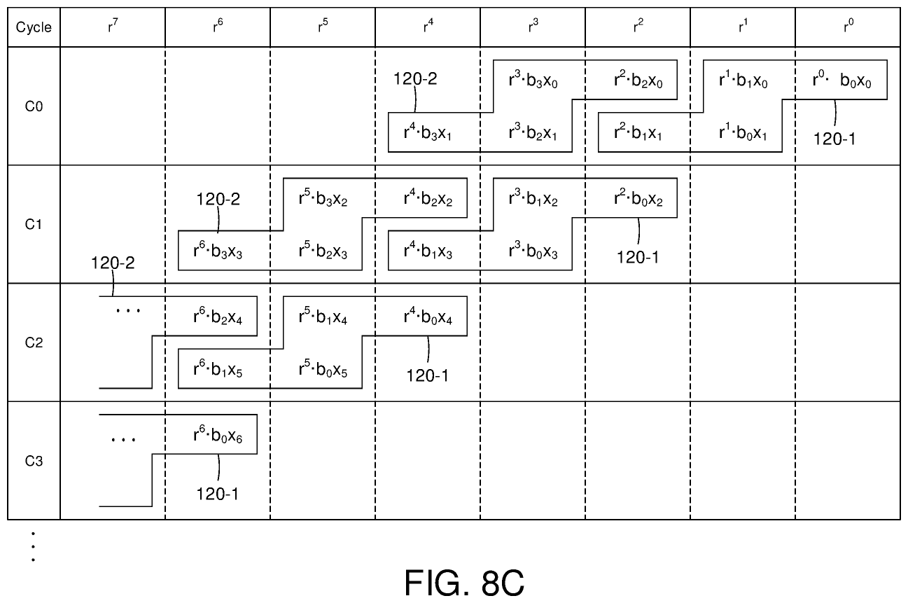

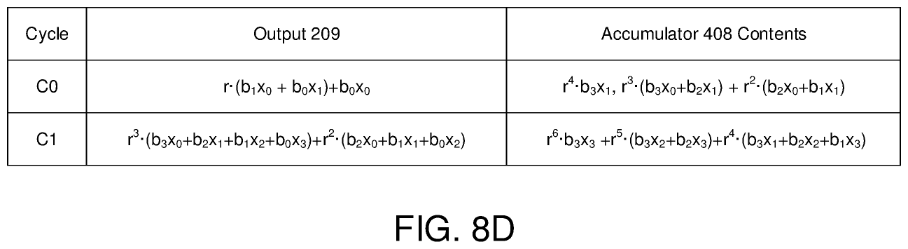

DSP 100 may include multiple parallel multiplier circuits, such as described below with reference to FIGS. 7 and 8A through 8D. Multiple parallel integer multiplication circuits may be useful to reduce computation time when convolving a kernel with a continuous data stream.

FIG. 7 is a block diagram of DSP 100, including parallel integer multiplication circuits 104-1 and 104-2, according to an embodiment. FIGS. 8A-8D illustrate states of DSP 100 (as depicted in FIG. 7), as DSP 100 convolves a 4-element kernel b(r) 402 (i.e., b₀, b₁, b₂, and b₃) with data stream x(i) 404, according to an embodiment.

In FIG. 7, selector circuitry 406 selects first and second sets of kernel elements 106-1 and 106-2, and segmentation circuitry 408 segments two sets of segmented binary integer values 108-1 and 108-2. Concatenation circuitry 103 concatenates kernel elements 106-1 as a vector 110-1, and concatenates segmented binary integer values 108-1 as a vector 112-1, as illustrated in FIG.8A. Concatenation circuitry 103 also concatenates kernel elements 106-2 as a vector 110-2, and concatenates segmented binary integer values 108-2 as a vector 112-2, as illustrated in FIG. 8B. FIG. 8C illustrates products 120-1 and 120-2 of multiplication circuits 104-1 and 104-2 over multiple cycles. FIG. 8D illustrates contents of accumulator circuitry 414 for cycles C0 and C1.

Further to the examples above, for a sufficiently large choice of r=2^{L}, the kernel (r) and segments of the input (r) can be mapped to wide integers for computing multiple rows of this computation with a single wide multiplier. For unsigned data, the assembly of the input integers amounts to plain concatenation, such as described in examples above. Also, the product is easily sliced into the computed column results as long as the lane width L is able to accommodate the maximum dot product result. Completing an output segment of the same length as the input segment processed in each step, the partial results in higher lanes are continued in the next computation step. If a multiply-accumulate operation is available, this may be accomplished by inserting the right-shifted partial results to the additive input in the next round.

For signed data, the wide integer composition is no longer a plain concatenation but turns into proper addition and subtraction with potential cross-lane borrows. In the context of deep neural networks, this rarely translates into effort that needs to be handled at inference time for several reasons. One reason is that activations (inputs) predominantly remain unsigned values by being subjected to activation functions like rectified linear unit (ReLU). Another reason is that signed input values can be shifted to an unsigned range by appropriately re-adjusting the bias value that is added to the output of a convolution layer in a convolutional neural network. Another reason is that, typically, signed weights (kernel parameters) can be handled and packed arithmetically before a ML model is deployed for inference. Moreover, the wide integer output can be ensured to be sliceable when a multiply-accumulate operation underlies the compute, and all lanes starting a new column of compute (rather than continuing one) are primed with an initial value of 2^{L-1} rather than 0. The implied offset in the ultimate lane result is easily corrected by inverting back the topmost bit. A consequence for the course of the computation is that no borrow from negative dot product accumulations in a column is able to spill over and pollute the next computation lane.

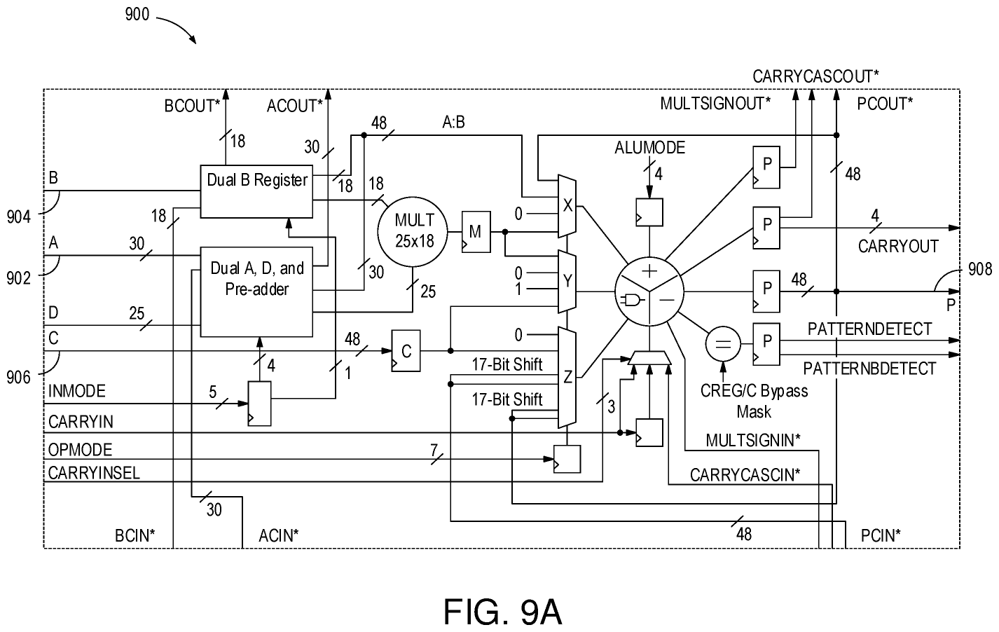

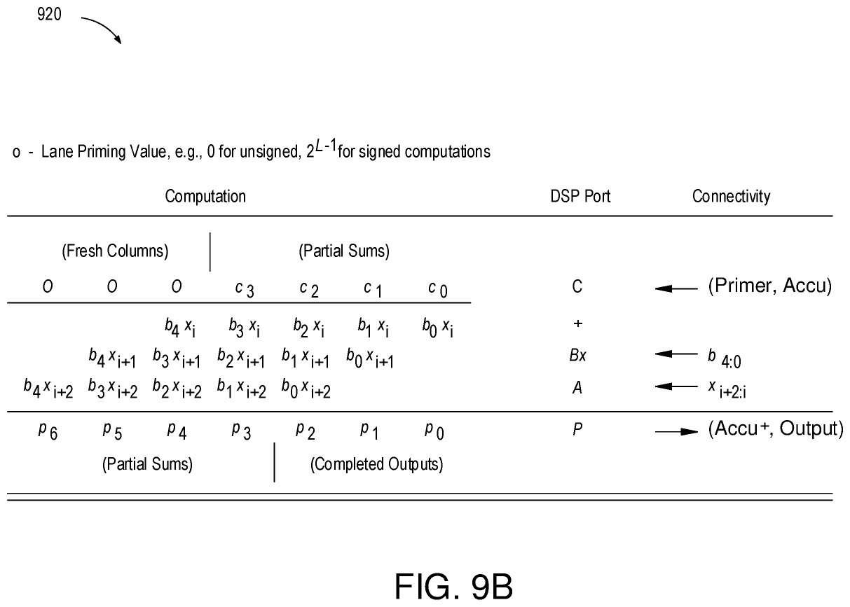

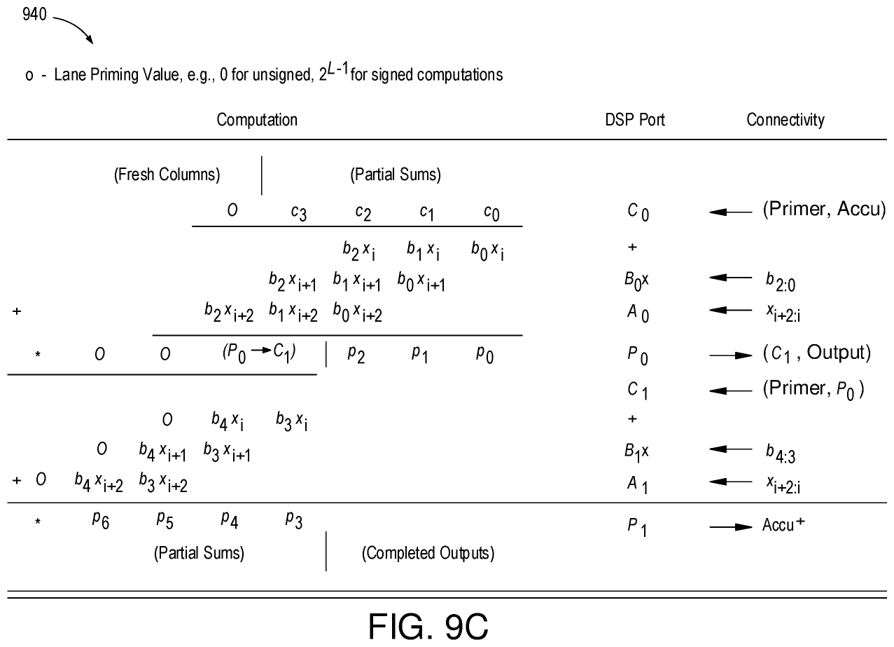

In an embodiment, DSP slices are used to implement a computation step convolving an arbitrarily sized kernel with an input segment. Even when multiple DSP slices are used to unroll the complete kernel width, the critical path remains bounded by the equivalent of two combinatorially-chained DSP slices as the compute columns are separated logically and no column spans more than two neighboring DSP slices. An example is provided below with reference to FIGS. 9A and 9B, based on a DSP48E1 slice developed by Xilinx Inc. Methods and systems disclosed herein are not, however, limited to DSP48E1 slices. FIG. 9A is a schematic diagram of a DSP48E1 slice 900, according to an embodiment. DSP48E1 slice 900 includes the following ports:

| Ref. No. | Port | Port Description |
|---|---|---|
| 902 | A Port | Input to DSP slice multiplier and secondary |
| | | input (subtrahend) to pre-adder |
| 904 | B Port | Second input to DSP slice multiplier |
| 906 | C Port | Input to DSP slice add/subtract |
| 908 | P Port | Cascaded input from a previous DSP slice. |
| | | Input to add/subtract. |

The number of compute lanes that fit an individual DSP slice depends on the lane width, which, in turn, is determined by bit widths of the operands. An arrangement of five parallel 10-bit lanes may be appropriate for inputs of approximately 4-bits, with an intrinsic accumulation of three compute rows. An achieved operational density of up to 9 multiply-accumulate operations (i.e., 18 Ops) per DSP slice exceeds the 4 multiply-accumulate operations (8 Ops) by more than 2×, which can be attained by guard-free single-vector packing with spill-over tracking and correction in the surrounding fabric.

FIGS. 9B and 9C illustrate example mappings 920 and 940, respectively, for convolving a 3-element input stream segment x_{i+2:i} with a 5-element kernel b_{4:0}, according to an embodiment. FIG. 9B demonstrates a mapping to a single DSP slice whose datapath is capable of accommodating the entire computation. FIG. 9C demonstrates a mapping by striping the kernel across two DSP slices whose datapaths are only capable of accommodating the input of three parallel kernel elements.

Each DSP slice implements a multiply-accumulate operation on wide integers. Assuming the naming of ports as given in FIG. 9A, the leveraged computation is:

$$P = C + B \cdot A$$

Multiple lower-precision elements of the kernel and of an input stream segment are put onto these wide datapaths. Mathematically, the elements are combined via a polynomial over a radix 2^{L} that facilitates their spacing into separable lanes.

A kernel or an input stream segment may have more elements than what the wide DSP datapath can accommodate. Then, the computation is striped across multiple DSP slices. If the element count of either kernel or input stream segment is not a full multiple of the lanes that can be accommodated on the assigned DSP datapath, the input is padded up to size. This is illustrated by the second DSP slice in the striped example mapping of FIG. 9C. Striping can be implemented through extra DSP resources or through a phased schedule in time over a shared DSP slice.

Except for the very first iteration and for a kernel size of 1, the performed multiply-accumulate operation picks up some partially computed sums from its preceding iteration. The corresponding state is communicated through a register, illustrated here as Accu. The notation Accu+ differentiates the state output of an iteration from its input.

Each iteration will start the dot product computation of new convolutional outputs. Their number is equivalent to the number of elements in the consumed input stream segment. The corresponding compute lanes are primed by a strating value. For an unsigned accumulation, this will typically be zero. For a signed accumulation, a starting value of 2^{L-1} is a more practical choice as it allows to avoid cross-lane borrows on the wide integer datapaths. This way, the output values remain separable without requiring a subsequent corrective computation. The priming value is referred to as o.

Note that the arrangement of the computation into columns is important in FIG. 9C. It can be easily validated that the striped mapping performs the same computation as the monolithic mapping of FIG. 9B. The striped mapping introduces a partial connection from the output P₀ of the first DSP slice to the lower-order lanes of the input C₁ of the second DSP slice. The second DSP slice continues the dot product accumulation on these lanes without necessarily completing them. Any remaining partial sums feed into the next iteration by passing through the Accu register.

In an embodiment, DSP 100 and/or DSP slices 900-1 and 900-2 updates kernel parameters in the background, without accessing external circuitry. In some situations, the same kemel is applied to a long input sequence or a comparatively large feature map before being preempted for computation of another channel or layer. In an embodiment, DSP 100 and/or DSP slices 900-1 and 900-2 include registers (e.g., registers B1 and B2) on an input path, which may be used as true on-chip storage devices for background updating of kernel parameters.

For example, if two kernels alternate back and forth for a long stretch of a an application, their two parameter sets can be shifted into the B1/B2 register cascade of all involved DSP slices arranged into a chain. This process may be relatively slow but extremely efficient with a single data entry point at the start of the chain. In operation, the currently active kernel is selected from B1 or B2 by a control (e.g., an INMODE control). If more kernels are rotated in the course of the application, the register cascade may still serve as a mediator between a lower-bandwidth on-chip or off-chip kernel parameter storage device and the parallel kernel application.

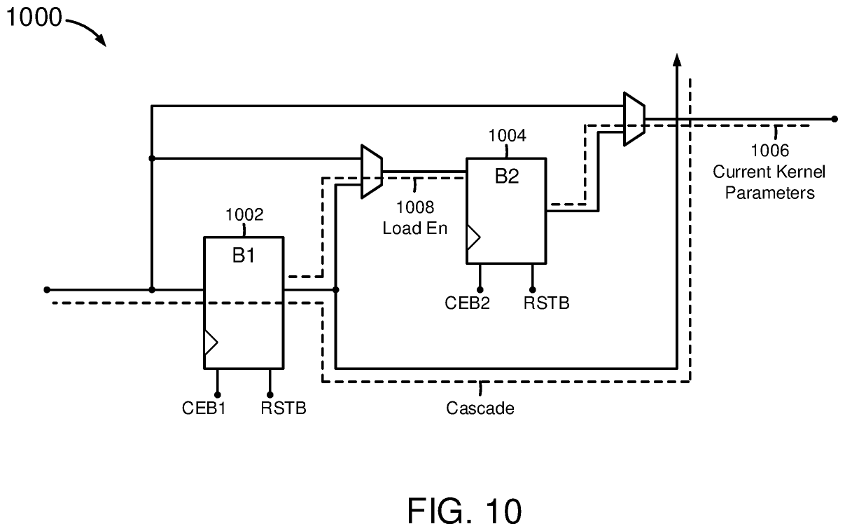

FIG. 10 illustrates register circuitry 1000 that updates kernel parameters, according to an embodiment. Register circuitry 1000 includes B1 registers 1002 and B2 registers 1004. In the example of FIG. 10, kernel parameters 1006 are held and served from B2 registers 1004, while B1 registers 1002 are organized into a cascade that loads the next set of parameters in the background. Kernel switching is effected by a load enable 1008 from B1 registers 1002 to B2 registers 1004. Register circuitry 1000 may be an integral part of DSP 100 and/or DSP 900.

Techniques disclosed herein may be generalized to multi-dimensional convolutions. Some application domains, such as artificial intelligence (AI) domains. may utilize higher-dimensional convolutions. Even in these cases, advantages of binary segmentation in terms of operational density can be exploited. For example, the multi-dimensional computation may be sliced into parallel 1D-computations whose efficiently computed individual results are then aggregated across the other dimensions. Some advantages of techniques disclosed herein are strongly predicated on low-precision computations, which is a natural fit for AI domains.

Techniques disclosed herein may also be applied to digital filters.

Techniques disclosed herein may also be applied to other hardened, or fixed-circuitry wide integer data paths, such as found in arrays of AI engines (AIEs) and graphical processor units (GPUs).

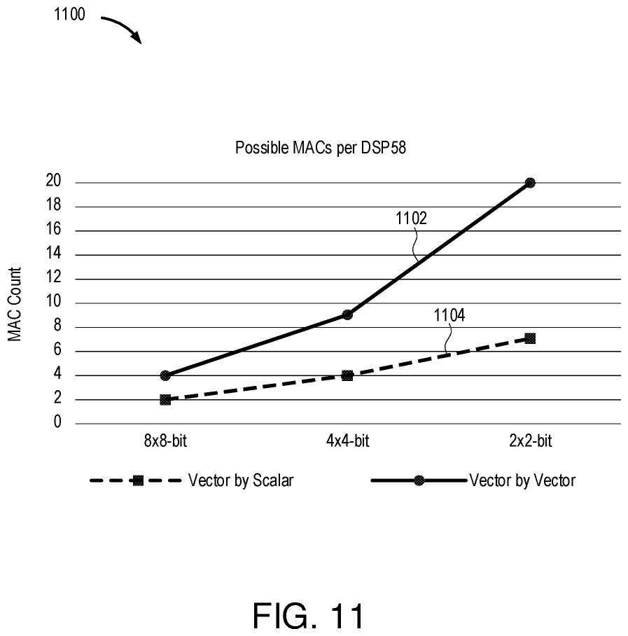

Techniques disclosed herein may provide relatively significant quadratic advantages relative to traditional one-sided vectorization. FIG. 11 is a graph 1100 that illustrates benefits terms of operational density per DSP58 slice for low-precision data types that are typical in machine-learning (ML) inference applications, according to an embodiment. Graph 1100 compares multiply-and-accumulate (MAC) counts for a vector-by-vector computation 1102, as disclosed herein, and MAC counts for a vector-by-scalar computation 1104, for various levels of precision (i.e., 8×8 bit, 4×4 bit, and 2×2 bit). For each level of precision, vector-by-vector computation 1102 requires fewer MAC counts than vector-by-scalar computation 1104. Exploiting both spatial dimensions of a multiplier array for vectorization provides benefits across the spectrum of graph 1100. The benefits are particularly pronounced for very low precisions (i.e., small integer values) that utilize a single small band of the whole multiplier array in a one-dimensional vectorization implementing a vector-by-scalar multiply.

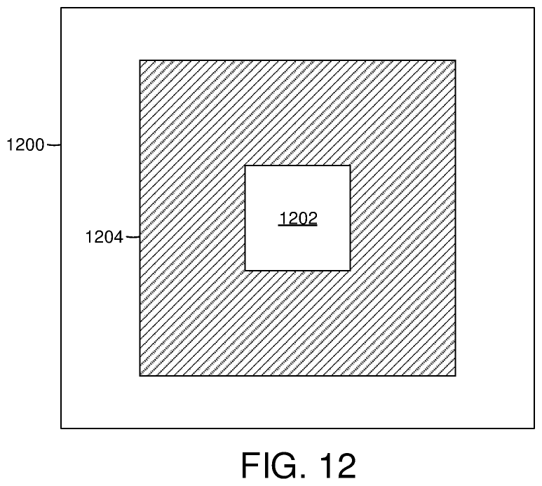

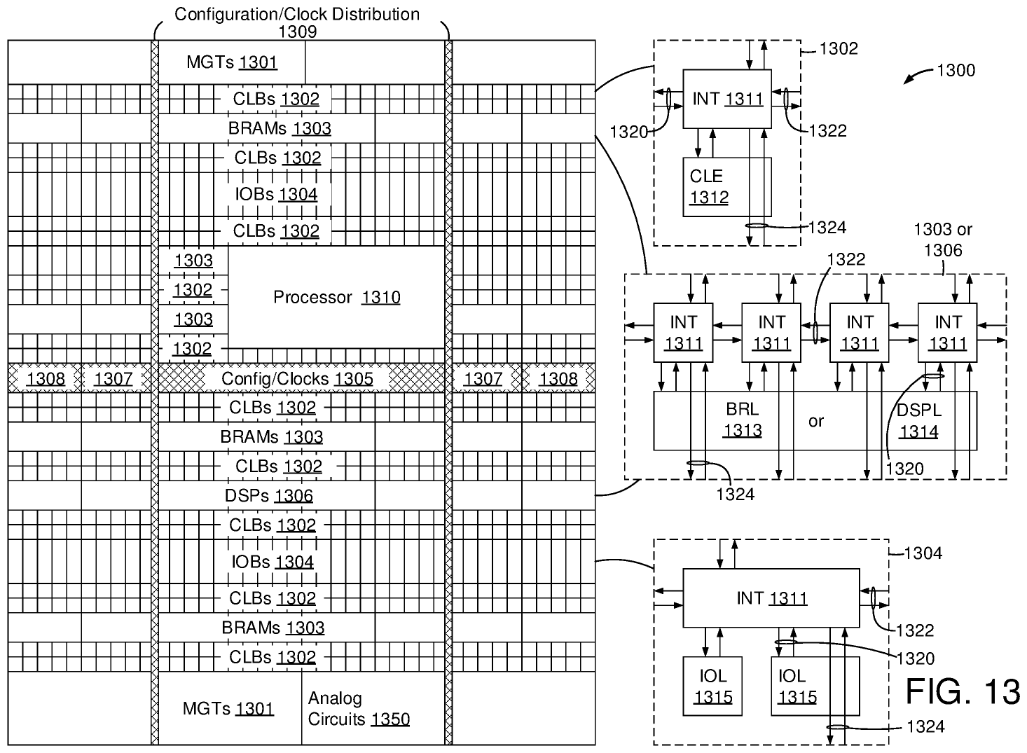

FIG. 12 is a block diagram of an integrated circuit (IC) device 1200, according to an embodiment. IC device 1200 may include one or more IC dies, which may be stacked in a 3-dimensional arrangement and/or may be positioned adjacent to one another in a 2-dimensional or 2.5-dimensional arrangement. In the example of FIG. 12. IC device includes a DSP 1202, which may represent DSP 100 and/or DSP 900. IC device 1200 may include and/or additional circuitry or subsystems.

IC device 1200 may further include a field-programmable gate array (FPGA) 1204. DSP 1202 may be provided within FPGA 1204 or outside of FPGA 1204.

FPGA 1204 may include one or more of a variety of types of configurable circuit blocks, such as described below with reference to FIG. 13.

FIG. 13 is a block diagram of configurable circuitry 1300, including an array of configurable or programmable circuit blocks or tiles, according to an embodiment. The example of FIG. 13 may represent a field programmable gate array (FPGA) and/or other IC device(s) that utilizes configurable interconnect structures for selectively coupling circuitry/logic elements, such as complex programmable logic devices (CPLDs).

In the example of FIG. 13, the tiles include multi-gigabit transceivers (MGTs) 1301, configurable logic blocks (CLBs) 1302, block random access memory (BRAM) 1303, input/output blocks (IOBs) 1304, configuration and clocking logic (Config/Clocks) 1305, digital signal processing (DSP) blocks 1306, specialized input/output blocks (I/O) 1307 (e.g., configuration ports and clock ports), and other programmable logic 1308, which may include, without limitation, digital clock managers, analog-to-digital converters, and/or system monitoring logic. The tiles further includes a dedicated processor 1310. One or more DSP blocks 1306 may serve as DSP 100 and/or DSP 900.

One or more tiles may include a programmable interconnect element (INT) 1311 having connections to input and output terminals 1320 of a programmable logic element within the same tile and/or to one or more other tiles. A programmable INT 1311 may include connections to interconnect segments 1322 of another programmable INT 1311 in the same tile and/or another tile(s). A programmable INT 1311 may include connections to interconnect segments 1324 of general routing resources between logic blocks (not shown). The general routing resources may include routing channels between logic blocks (not shown) including tracks of interconnect segments (e.g., interconnect segments 1324) and switch blocks (not shown) for connecting interconnect segments. Interconnect segments of general routing resources (e.g., interconnect segments 1324) may span one or more logic blocks. Programmable INTs 1311, in combination with general routing resources, may represent a programmable interconnect structure.

A CLB 1302 may include a configurable logic element (CLE) 1312 that can be programmed to implement user logic. A CLB 1302 may also include a programmable INT 1311.

A BRAM 1303 may include a BRAM logic element (BRL) 1313 and one or more programmable INTs 1311. A number of interconnect elements included in a file may depends on a height of the tile. A BRAM 1303 may, for example, have a height of five CLBs 1302. Other numbers (e.g., four) may also be used.

A DSP block 1306 may include a DSP logic element (DSPL) 1314 in addition to one or more programmable INTs 1311. An IOB 1304 may include, for example, two instances of an input/output logic element (IOL) 1315 in addition to one or more instances of a programmable INT 1311. An I/O pad connected to. for example, an I/O logic element 1315, is not necessarily confined to an area of the I/O logic element 1315.

In the example of FIG. 13, config/clocks 1305 may be used for configuration, clock, and/or other control logic. Vertical columns 1309 may be used to distribute clocks and/or configuration signals.

A logic block (e.g., programmable of fixed-function) may disrupt a columnar structure of configurable circuitry 1300. For example, processor 1310 spans several columns of CLBs 1302 and BRAMs 1303. Processor 1310 may include one or more of a variety of components such as, without limitation, a single microprocessor to a complete programmable processing system of microprocessor(s), memory controllers, and/or peripherals.

In FIG. 13, configurable circuitry 1300 further includes analog circuits 1350, which may include, without limitation, one or more analog switches 137, multiplexers, and/or de-multiplexers. Analog switches 137 may be useful to reduce leakage current.

FIG. 13 is provided for illustrative purposes. Configurable circuitry 1300 is not limited to numbers of logic blocks in a row, relative widths of the rows, numbers and orderings of rows, types of logic blocks included in the rows, relative sizes of the logic blocks, illustrated interconnect/logic implementations, or other example features of FIG. 13.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. An integrated circuit (IC) device, comprising:
pre-processing circuitry comprising concatenation circuitry configured to concatenate first and second sets of binary integer values as respective first and second vectors; and
an integer multiplier circuit comprising first and second inputs coupled to an output of the pre-processing circuitry.

2. The IC device of claim 2, wherein the concatenation circuitry is further configured to pad the concatenated binary integer values based on a scaling factor.

3. The IC device of claim 1, wherein:
an output of the multiplier circuit represents a one-dimensional convolution of the first and second vectors.

4. The IC device of claim 1, wherein:
the concatenation circuitry is further configured to map the first and second vectors to respective first and second polynomials based on a scaling factor; and
the integer multiplier circuit is configured to multiply the first and second polynomials to provide a polynomial product of first and second polynomials.

5. The IC device of claim 4, wherein the integer multiplier circuit is further configured to multiply the first and second polynomials to provide the polynomial product in a first cycle, and wherein the IC device further comprises post-processing circuitry that comprises:
accumulation circuitry configured to retain one or more terms of the polynomial product of the first cycle, and to combine the one or more retained terms with a polynomial product of a subsequent cycle.

6. The IC device of claim 5, wherein post-processing circuitry further comprises:
slicer circuitry configured to segregate the terms of the polynomial product of the first cycle based on the scaling factor.

7. The IC device of claim 6, wherein each term i of the polynomial product is scaled by rⁱ, wherein i>zero.

8. The IC device of claim 4, wherein:
the first set of binary integer values comprise elements of a weight kernel;
the pre-processing circuitry further comprises segmentation circuitry configured to segment the second set of binary integer values from a data stream;
the integer multiplier circuit is further configured to multiply the first and second polynomials during a first cycle;
the IC device further comprises post-processing circuitry that comprises accumulator circuitry configured to retain one or more terms of the polynomial product of the first cycle, and to combine the one or more retained terms with a polynomial product of a subsequent cycle; and
outputs of the post-processing circuitry, over time, represent a convolution of the kernel and the data stream.

9. The IC device of claim 1, further comprising a field-programmable gate array (FPGA), wherein:
the FPGA comprises a digital signal processor (DSP);
the DSP comprises the multiplier circuit; and
the pre-processing circuitry is configured within programmable circuitry of the FPGA.

10. An integrated circuit (IC) device, comprising:
a digital signal processor (DSP) comprising a plurality of multiplier circuits configured to compute a linear convolution of a kernel and a data stream over multiple cycles.

11. The IC device of claim 10, further comprising pre-processing circuitry configured to:
select first and second sets of kernel elements for a cycle, and map the first and second sets of kernel elements to respective first and second kernel polynomials based on a scaling factor;
segment the data stream to provide first and second sets of binary integer values for the cycle, and map the first and second sets of binary integer values to respective first and second data polynomials based on the scaling factor; and
provide the first kernel polynomial and the first data polynomial to a first one of the multiplier circuits and provide the second kernel polynomial and the second data polynomial to a second one of the multiplier circuits;
wherein the first and second multiplier circuits compute respective first and second polynomial products in the first cycle.

12. The IC device of claim 11, further comprising post-processing circuitry configured to:
slice outputs of the first and second multiplier circuits based on the scaling factor to segregate terms of the first and second polynomial products;
aggregate like-terms of the first and second polynomial products and terms of polynomial products retained from one or more prior cycles, based on exponents of the scaling factor associated with the respective terms;
output a set of like-terms when processing of the associated segments of the data stream is complete; and
retain terms for which processing of the associated segments of the data stream is incomplete.

13. The IC device of claim 12, further comprising a field-programmable gate array (FPGA), wherein:
the FPGA comprises the DSP;
the pre-processing circuitry and the post-processing circuitry are configured within programmable circuitry of the FPGA.

14. The IC device of claim 12, further comprising a field-programmable gate array (FPGA), wherein
the FPGA comprises the DSP; and
the DSP comprises the pre-processing circuitry and the post-processing circuitry.

15. The IC device of claim 11, further comprising:
a first set of registers configured to provide the kernel elements for a current cycle to the pre-processing circuitry; and
a second set of registers configured to hold kernel elements for a subsequent cycle and to update the first set of registers with the kernel elements for the subsequent cycle.

16. The IC device of claim 15, wherein the DSP further comprises the first and second set of registers.

17. An integrated circuit (IC) device, comprising:
pre-processing circuitry configured to encode elements of a kernel as kernel polynomials and encode segments of a data stream as data polynomials;
a plurality of multiplier circuits, each configured to multiply a respective one of the kernel polynomials and a respective one of the data polynomials to provide a polynomial product; and
post-processing circuitry configured to,
slice outputs of the multiplier circuits based on a scaling factor to segregate terms of the polynomial products of the multiplier circuits,
aggregate like-terms of the polynomial products of the multiplier circuits and terms of polynomial products of the multiplier circuits retained from one or more prior cycles, based on exponents of the scaling factor associated with the respective terms,
output a set of like-terms when processing of the associated segments of the data stream is complete, and
retain terms for which processing of the associated segments of the data stream is incomplete.

18. The IC device of claim 17, wherein the pre-processing circuitry is further configured to encode the kernel polynomials and the data polynomials as respective sets of integer values separated by padding based on the scaling factor.

19. The IC device of claim 17, further comprising:
a set of first registers configured to provide the kernel elements for a current cycle to the pre-processing circuitry; and
a set of second registers configured to hold kernel elements for a subsequent cycle and to update respective ones of the first registers with the kernel elements for the subsequent cycle.

20. The IC device of claim 19, further comprising a field-programmable gate array (FPGA), wherein:
the FPGA comprises an array of digital signal processors (DSPs); and
the DSPs comprise respective ones of the first and second registers.
